(19) United States
(12) Patent Application Publication
(10) Pub. No.: US 2015/0176616 A1
(43) Pub. Date: Jun. 25, 2015

(54) HEATER SYSTEM FOR PRESSURIZABLE AND FLUID-RETAINING VESSEL

(71) Applicant: Caterpillar Inc., Peoria, IL (US)

(72) Inventors: Kuldip S. Turke, Munster, IN (US); Daniel G. Wear, Peoria, IL (US); Brent A. Biernbaum, Romeoville, IL (US)

(73) Assignee: Caterpillar Inc., Peoria, IL (US)

(21) Appl. No.: 14/639,142

(22) Filed: Mar. 5, 2015

(51) Int. Cl. F15B 21/04; F15B 1/04

(52) U.S. Cl. CPC F15B 21/042; F15B 1/04

(57) ABSTRACT

A heater system for a pressurizable and fluid-retaining vessel is disclosed. The heater system includes a frame assembly, a heater element, a temperature controller, and an insulation member. The frame assembly includes a first portion, which is structured and arranged to at least partially overlay the pressurizable and fluid-retaining vessel. The frame assembly includes a second portion, which is structured and arranged to mountably couple to the machine. The heater element is adapted to heat the pressurizable and fluid-retaining vessel. The heater element is supported within the first portion of the frame assembly. The temperature controller is adapted to regulate temperature of the pressurizable and fluid-retaining vessel. The insulation member encloses the pressurizable and fluid-retaining vessel and the heater element.

### TECHNICAL FIELD

The present disclosure generally relates to pressurizable and fluid-retaining vessels. More particularly, the present disclosure relates to a heater system for pressurizable and fluid-retaining vessels.

### BACKGROUND

Machines, such as motor graders, snow ploughs, wheel loaders, and the like, may operate in cold climatic conditions. These machines may be subjected to damage due to low temperatures, as various systems in these machines, such as cooling system, lubrication system, transmission system, braking system, and the like, may be affected due to freezing ambient temperatures. The cooling system and the lubrication system of a machine may lose heat after sometime upon shutdown. However, the transmission system and the hydraulic system may lose heat more rapidly due to exposure to a relatively cold ambience. Such transmission system may include one or more accumulators, which may be damaged due to the cold ambience. More particularly, the accumulator generally includes a flexible diaphragm, which separates gas from hydraulic oil. Modern diaphragm style accumulators are designed to operate in a moderate temperature range, however, mobile equipment often pushes the limits of accumulator technology in arctic climates. Exposure to temperatures below the rated temperatures can lead to cracking and eventual failure of the diaphragm.

U.S. Pat. No. 4,046,167 discloses a mechanical accumulator coupled with an accumulator pump. The accumulator pump includes an accumulator pump block plate with a bore, which receives a thermostatically controlled electric heater assembly. The electric heater assembly ensures that hydraulic fluid in the passage of the accumulator pump, block plate and associated components are at an optimum temperature in extremely cold weather. This reference discusses indirect heating of the hydraulic fluid to be delivered to the accumulator. However, the '167 reference fails to address a mechanism to directly heat the accumulator.

### SUMMARY OF THE INVENTION

Various aspects of the present disclosure describe a heater system for a pressurizable and fluid-retaining vessel. The heater system includes a frame assembly, a heater element, a temperature controller, and an insulation member. The frame assembly includes a first portion, which is structured and arranged to at least partially overlay the pressurizable and fluid-retaining vessel. Further, the frame assembly includes a second portion, which is structured and arranged to mountably couple to a machine. The heater element is adapted to communicate heat to the pressurizable and fluid-retaining vessel. The heater element is supported within the first portion of the frame assembly. The temperature controller is adapted to regulate temperature of the pressurizable and fluid-retaining vessel. The insulation member is adapted to enclose the pressurizable and fluid-retaining vessel and the heater element.

### BRIEF DESCRIPTION OF THE DRAWINGS

FIG. 1 is a perspective view of two pressurizable and fluid-retaining vessels coupled with a heater system contained within an insulation member, with a partial cross sectional view of one of the pressurizable and fluid-retaining vessels, in accordance with the concepts of the present disclosure;

FIG. 2 is an exploded view of the pressurizable and fluid-retaining vessel and the heater system of FIG. 1, in accordance with the concepts of the present disclosure;

FIG. 3 is a perspective view of a frame assembly and a heater element of the heater system of FIG. 2, in accordance with the concepts of the present disclosure; and

FIG. 4 is a perspective view of the frame assembly of FIG. 3, showing temperature controllers and mounting surface for the pressurizable and fluid-retaining vessel, in accordance with the concepts of the present disclosure.

### DETAILED DESCRIPTION

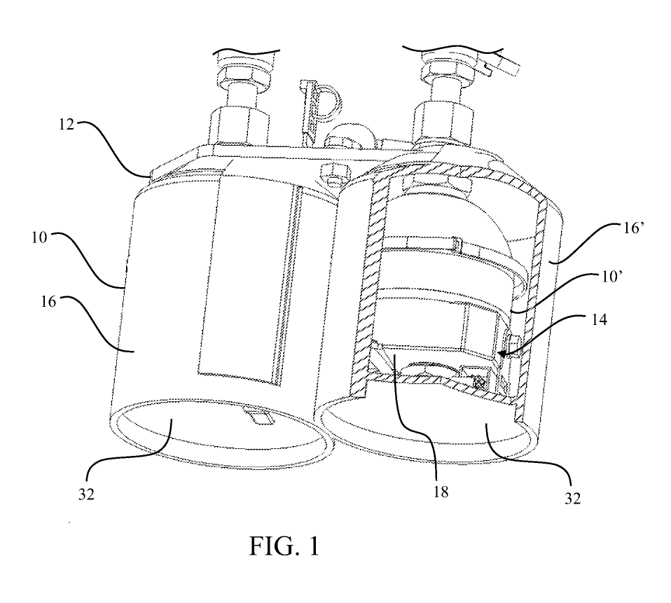

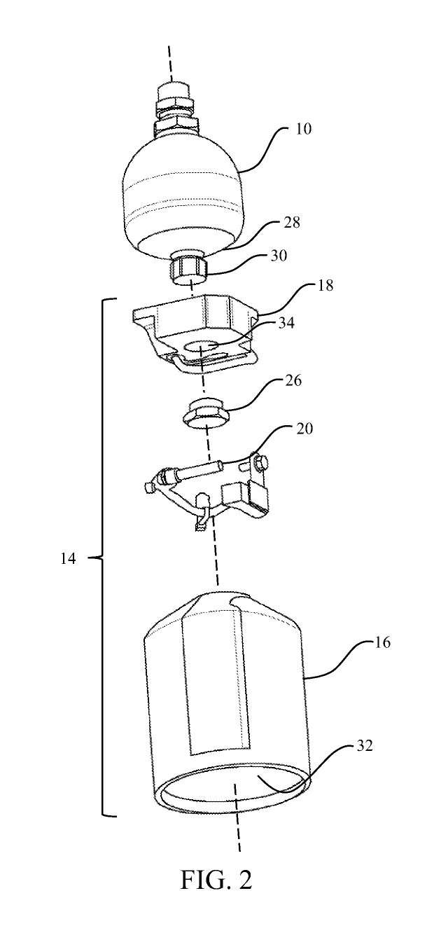

Referring to FIG. 1, two pressurizable and fluid-retaining vessels 10 and 10′ are shown. The pressurizable and fluid-retaining vessels 10 and 10′ are supported by an attachment member 12 of a machine (not shown). The pressurizable and fluid-retaining vessels 10 and 10′ are equipped with a heater system 14. The heater system 14 includes an insulation member 16. The heater system 14 includes various other components, which will be described in detail in the specification for FIG. 2.

The pressurizable and fluid-retaining vessels 10 and 10′ are housed within the insulation member 16 and 16′. The pressurizable and fluid-retaining vessels 10 and 10′ are hereinafter referred to as vessels. The vessel 10 is covered by the insulation member 16 and the vessel 10′ is covered by the insulation member 16′, a partial cut-out of the vessel 10′ is illustrated in FIG. 1, to show the heater system 14 housed within the insulation member 16′.

Referring to FIG. 2, the vessel 10 and the heater system 14 is shown in an exploded view. The heater system 14 includes the insulation member 16, a frame assembly 18, a heater element 20, a primary temperature controller 22, a secondary temperature controller 24, and an installation nut 26. The vessel 10 includes a base portion 28, which is attached to a tail portion 30. The vessel 10 is fitted with the heater system 14 via the installation nut 26. The installation nut 26 fastens the tail portion 30 of the vessel 10 to the heater system 14. The vessel 10, along with the heater system 14, is covered by the insulation member 16. The insulation member 16 includes a bottom portion 32 to cover bottom of the frame assembly 18. The insulation member 16 encloses the vessel 10 and at least a portion of the frame assembly 18. The insulation member 16 may be a wrap-around member, which is wrapped around the vessel 10 and the frame assembly 18. The frame assembly 18 includes a through-hole 34. The through-hole 34 has a diameter slightly larger than the diameter of the tail portion 30 of the vessel 10.

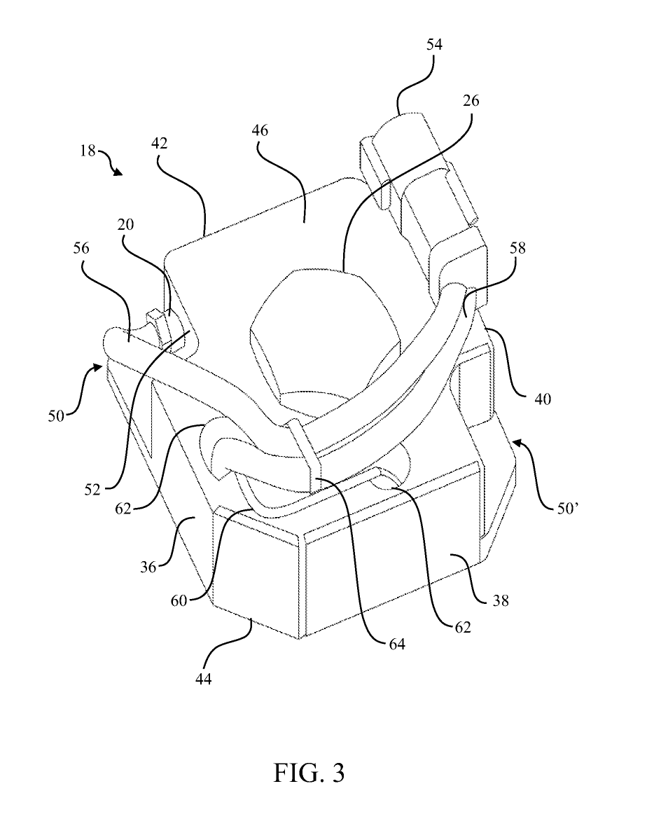

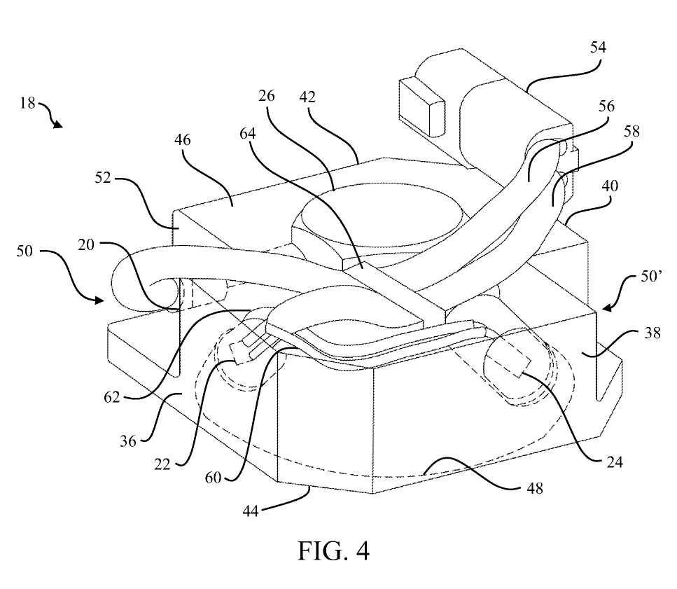

Referring to FIGS. 3 and 4, the frame assembly 18 includes a through-hole 34 (FIG. 2), four lateral sides 36, 38, 40, and 42, a first portion 44 and a second portion 46. The frame assembly 18 may be composed of aluminum or a similar metal. The through-hole 34 (FIG. 2) extends from the first portion 44 to the second portion 46. The first portion 44 includes a concave surface 48. The base portion 28 of the vessel 10 (FIG. 2) is mounted to the concave surface 48 of the first portion 44. In other words, the first portion 44 partially overlays the vessel 10. The concave surface 48 of the first portion 44 are structured to match the outer spherical geometry of the base portion 28 of the vessel 10 (FIG. 2). The vessel 10 (FIG. 2) may be attached to the frame assembly 18 by use of a thermal paste. The vessel 10 is held together with the first portion 44 with thermal paste. In addition, the tail portion 30 (FIG. 2) passes to the second portion 46, through the through-hole 34, to fit the vessel 10 substantially tightly onto the concave surface 48. The second portion 46 is attached to the machine (not shown), to mountably couple the heater system 14 to the machine (not shown).

A corner formed by the lateral sides 36 and 42 defines a recess portion 50. Similarly, a corner formed by the lateral sides 38 and 40 defines a recess portion 50′. The recess portions 50 and 50′ are disposed substantially diagonally opposite to each other. The recess portion 50 includes a wall portion 52, which is perpendicular to the second portion 46. The wall portion 52 is structured to include a slot via which the heater element 20 may be plugged in to the frame assembly 18 and supported within the frame assembly 18. The heater element 20 is connected to an adapter 54, via a first wire 56. The adapter 54 may connect to a machine harness (not shown).

Further, the frame assembly 18 houses the primary temperature controller 22 and the secondary temperature controller 24. The primary temperature controller 22 and the secondary temperature controller 24 are arranged within the frame assembly 18 and beneath the concave surface 48 of the first portion 44. The primary temperature controller 22 and the secondary temperature controller 24 are in contact with the first portion 44 to monitor the temperature of the vessel 10. The primary temperature controller 22 and the secondary temperature controller 24 are functional between a high temperature threshold and a low temperature threshold. The primary temperature controller 22 is connected to the adapter 54, via a second wire 58. The primary temperature controller 22 and the secondary temperature controller 24 are connected to each other via an integrated wire 60.

In addition, the second portion 46 includes a machined pocket 62 and a bracket 64. The machined pocket 62 is potted with a suitable substance to seal the wires 56, 58, and 60, and the temperature controllers 22 and 24, in place. The bracket 64 is structured to hold the first wire 56 and the second wire 58. The second portion 46 also includes an opening of the through-hole 34, which allows the tail portion 30 (FIG. 2) to emerge out of the second portion 46 and be secured onto the second portion 46 via the installation nut 26.

### INDUSTRIAL APPLICABILITY

In operation, the vessels 10 and 10′ are attached to the heater system 14, which maintains temperature of the vessels 10 and 10′ at an optimum level, that is, generally above −26 Centigrade. The heater element 20 draws power via the adapter 54 and results in heating of the heater element 20. As the heater element 20 is housed within the frame assembly 18, the heater element 20 communicates heat to the vessel 10. In this way, the heater element 20 transfers heat to the first portion 44, via conduction. As the first portion 44 heats, the concave surface 48 of the frame assembly 18 transfers the heat to the base portion 28 of the vessel 10, via conduction. When the heat of the base portion 28 of the vessel 10 increases, temperature of hydraulic fluid inside the vessel 10 also increases. This allows for maintenance of the temperature of the hydraulic fluid in the vessel 10 at an optimum value. In this manner, damage to diaphragm of the vessel 10 in cold climatic conditions is mitigated.

During a heating process, the primary temperature controller 22 monitors the high and low temperature thresholds of the vessel 10. Upon detection of the high temperature threshold of the vessel 10, the primary temperature controller 22 regulates the heating process of the vessel 10 by halting the operation of the heater element 20. In circumstances, when the primary temperature controller 22 fails, the secondary temperature controller 24 may come into operation to monitor the temperature of the vessel 10. Also, the insulation member 16 allows for a more effective heating process as the vessel 10 and the heater system 14 are shielded from the ambient surroundings. This reduces heat loss from the vessel 10 and the heater system 14 to an ambient environment. Reduction in heat loss results in rapid heating of the vessel 10. Hence, this reduces the time elapsed in heating the vessel 10 to the optimum temperature.

The heater system 14 employs the heater element 20, which heats the vessel 10, directly. The insulation member 16 adds to the efficiency of this heating process. Installation of the frame assembly 18, below the vessel 10, causes the heat induced by the heater element 20, to rise in the vessel 10. This results in a relatively fast rate of heating of the vessel 10. In addition, the temperature controllers 22 and 24 are embedded in the frame assembly 18, to monitor the temperature of the vessel 10 and keep the heating process below the high temperature threshold.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A heater system for a pressurizable and fluid-retaining vessel, the heater system comprising:
a frame assembly having a first portion structured and arranged to at least partially overlay the pressurizable and fluid-retaining vessel and a second portion of the frame assembly being structured and arranged to mountably couple to a machine;
a heater element adapted to communicate heat to the pressurizable and fluid-retaining vessel, the heater element being supported within the frame assembly;
a temperature controller adapted to regulate temperature of the pressurizable and fluid-retaining vessel; and
an insulation member sized to enclose the pressurizable and fluid-retaining vessel and the heater element.
